(19) United States
(12) Patent Application Publication
(10) Pub. No.: US 2013/0166670 A1
(43) Pub. Date: Jun. 27, 2013

(54) NETWORKED STORAGE SYSTEM AND METHOD INCLUDING PRIVATE DATA NETWORK

(71) Applicants: James George Wayda, Laguna Niguel, CA (US); John L. Bertagnolli, Parker, CO (US); Mark Lonsdale, Redondo Beach, CA (US); Alex Grossman, Lomita, CA (US)

(72) Inventors: James George Wayda, Laguna Niguel, CA (US); John L. Bertagnolli, Parker, CO (US); Mark Lonsdale, Redondo Beach, CA (US); Alex Grossman, Lomita, CA (US)

(21) Appl. No.: 13/333,992

(22) Filed: Dec. 21, 2011

(51) Int. Cl. G06F 15/16; G06F 15/167

(52) U.S. Cl. 709/213; 709/219

(57) ABSTRACT

A networked storage system includes a source mass storage device coupled to a client via a storage area network (SAN). A target mass storage device is coupled to the source mass storage device via a private data network. The source mass storage device stores source data which is provided to the client via the SAN in response to a request by the client to read the data. If the request is to copy or move the source data, however, the source mass storage device determines an identifier for the target mass storage device and directly provides, based on the identifier, the source data to the target mass storage device via the private data network. The transfer via the private data network bypasses the client and the SAN.

### BACKGROUND

Embodiments of the present invention relate generally to network-based storage of digital data.

Network-based storage of digital data provides a number of advantages over local storage such as, for example, improved availability and accessibility of the data by multiple users, centralization of storage administration, and increased storage capacity. As such, industries such as cinema, television, and film advertising that generate, manipulate, and share large amounts of data, often take advantage of network-based storage systems for video production, post-production, delivery, and consumption.

FIG. 1 is a block diagram of a network-based storage system that is typically employed for video-post production. The system includes one or more storage clients 1000a-1000d coupled to one or more storage nodes 2000a-2000d over one or more storage area networks (SANs) 3000a-3200d. The one or more SANs are interfaces between the storage clients and the storage nodes. The different SANs are coupled together over a data communications network 3400 such as, for example, an Ethernet network.

Data migration from one SAN to another typical involves reading files from a source storage node, such as an ingest storage node 2000a, and writing it to a target storage node, such as a production storage node 2000b. In this regard, a copy of data stored in the ingest storage node 2000a is transferred to its client 1000a over the ingest SAN 3200a, and then over the data communications network 3400 to a production storage client 1000b. The production storage client 1000b in turn writes the received data over the production SAN 3200b to the production storage node 2000b. This type of transfer may create a heavy traffic load on the data communications network 3400 and additional traffic load on the ingest and production SANs 3200a, 3200b, impacting normal data operations. Although the overhead of transferring the data over the data communications network 3400 is eliminated where the storage client 1000a has access to both the source and destination SANs, it does not eliminate the traffic on the SANs. Even when data is transferred within a single file system or between two file systems within the same SAN, the conventional mechanism of effectuating this transfer requires data to be read and written across the SAN(s) in two different operations. For example, when a file is copied from one folder to another folder within the same file system, the file is first retrieved from the storage node and transferred to the storage client over the SAN, and the read data is then transferred from the client back to the storage node over the same SAN. Such traffic on the SAN can have negative impact on normal operations that also utilize the SAN for operations other than data transfer.

Although the network congestion created via typical data transfers over the data communications network 3400 may be alleviated by a secondary private interconnect between the storage clients, this solution increases complexity to the users by requiring the users to reconfigure their storage clients with additional hardware and software. Furthermore, a secondary private interconnect between the storage clients does not circumvent the SAN congestion as data migrates within the same SAN or between two different SANs.

The above problem is not unique to the field of video postproduction. Similar issues of reduced network performance may also arise in fields that utilize SANs to transfer large amounts of data, such as, for example, scientific research, music production, data forensics, satellite imaging, and the like.

Accordingly, what is desired is a network-based storage system and method for transferring data within or between SANs with improved performance for the data transfers.

### SUMMARY

Embodiments of the present invention are directed to a system and method for transferring data between data storage units along a separate data transfer network to reduce the performance impact of transferring large amounts of data between different network storage devices over an IP-based network and/or storage area network. Apart from initiating the data transfer, a client device is not involved in the actual movement of the data from a source to a destination. Instead, data is transferred directly from one storage unit to another (or within a single storage unit), without having the data traverse to the client device. The client device, as well as the storage area network coupled to the client device, is therefore bypassed in this data transfer. This helps minimize traffic on the IP-based network and/or storage area network.

Accordingly, the present invention are directed to a networked data storage system which includes a source mass storage device storing source data, and a target mass storage device coupled to the source mass storage device via a private data network. The source mass storage device is in turn coupled to a source client via a storage area network (SAN). In response to a first type of request from the source client, the source mass storage device is configured to provide the source data to the source client via the SAN. However, in response to a second type of request from the source client, the source mass storage device is configured to provide the source data to the target mass storage device via the private data network. In providing the source data to the target mass storage device, the source mass storage device is configured to receive an identifier identifying the target mass storage device.

According to one embodiment of the invention, the first type of request is a request to read the source data and the second type of request is a request to copy or move the source data to the target mass storage device.

According to one embodiment of the invention, the source mass storage device is configured to determine the identifier identifying the target mass storage device based on information provided in the second type of request. The information may be an address of a target SAN, where the target mass storage device is coupled to a target client via the target SAN. The target SAN may be the same as the SAN coupling the source client to the source mass storage device.

According to one embodiment of the invention, the source storage device includes a processor and a memory storing computer program instructions. The processor is configured to execute the program instructions, where the program instructions include receiving a list of source blocks; retrieving the source data based on the source blocks; writing the retrieved source data in the memory; reading the source data from the memory; generating a request packet including the read source data; establishing connection with the target mass storage device; and transmitting the request packet to the target mass storage device via the established connection. The connection may be a point-to-point connection.

According to one embodiment, the source blocks are identified by a file system controller based on file system metadata.

According to one embodiment of the invention, the target mass storage device is configured to pre-allocate storage space for storing the source data. The target mass storage device may be configured to receive the source data from the source mass storage device and store the received source data in the pre-allocated storage space.

According to one embodiment of the invention, the source data is stored in a plurality of source mass storage devices, where each of the plurality of source mass storage devices is configured to concurrently retrieve a portion of the source data and provide the retrieved portion to one or more target mass storage devices for storing therein.

According to one embodiment of the invention, in response to a plurality of second type requests from one or more source clients, the source mass storage device is configured to concurrently provide data requested by each of the plurality of second type requests, to one or more target mass storage devices, for concurrently storing the data in the one or more target mass storage devices.

According to one embodiment of the invention, the private data network provides a point-to-point communication channel between the source mass storage device and the target mass storage device for transferring the source data from the source mass storage device to the target mass storage device.

According to one embodiment of the invention, the source data from the source mass storage device is transferred to the target mass storage device independent of involvement by the source client in moving the source data.

According to one embodiment of the invention, in response to a third type of request from the source client, the source mass storage device is configured to transfer the source data from a first location in the source mass storage device to a second location in the source mass storage device, where the transfer bypasses the SAN.

The present invention is also directed to a method for transferring source data stored in the source mass storage device. In response to a first type of request, the source data is provided to the source client by the source mass storage device via the SAN. In response to a second type of request, an identifier identifying the target mass storage device is provided to the source mass storage device, and the source data is provided, based on the identifier, to the target mass storage device via the private data network.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram of a network-based storage system hat is typically employed for video-post production;

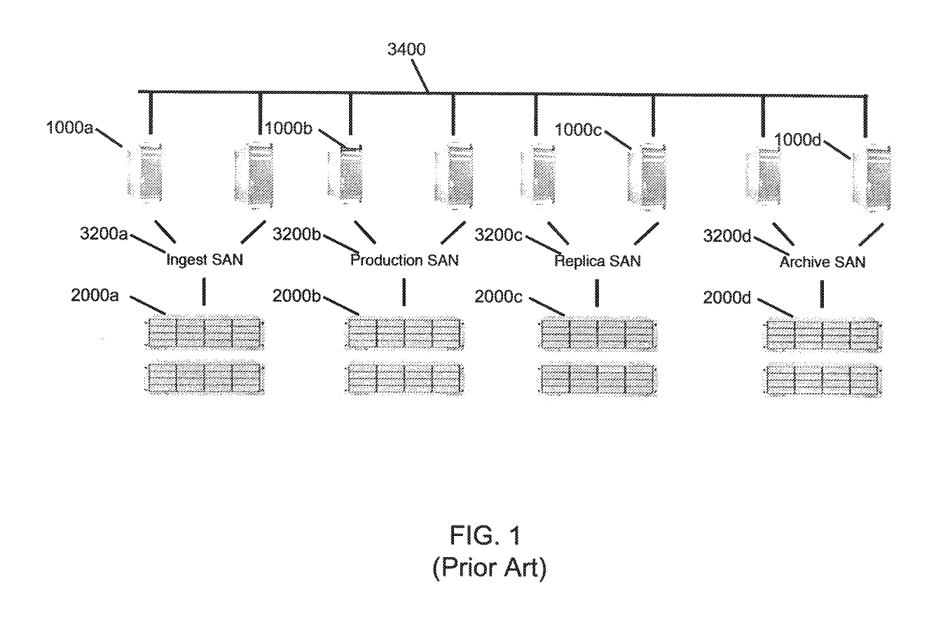

FIG. 2 is a block diagram of a networked storage system according to one embodiment of the invention;

FIG. 3 is a flow diagram of a process executed by various modules of the networked storage system of FIG. 2 for transferring a data file from a source location to a target location over a private network, according to one embodiment of the invention;

FIG. 4 is a flow diagram of a process for intra-storage transfer according to one embodiment of the invention;

FIG. 5 is a flow diagram of a process for registering a supervisor module with a parent command and control module according to one embodiment of the invention; and

FIG. 6 is a block diagram illustrating an exemplary data transfer of files stored in specific LUNs according to one embodiment of the invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

In general terms, embodiments of the present invention are directed to a networked data storage system with intelligence and infrastructure to directly transfer large amounts of data from a source location to a target location, within a file system of a single storage device, between different file systems within the same SAN, and/or between different SANs. The transfer is aimed to occur in a manner that is transparent to users, and with minimal impact on I/O performance. Hereinafter, the term transfer is used to broadly encompass the transfer of data copied from a source location without deleting the data from the source, as well as the migration of data from the source to a target location that deletes the data at the source.

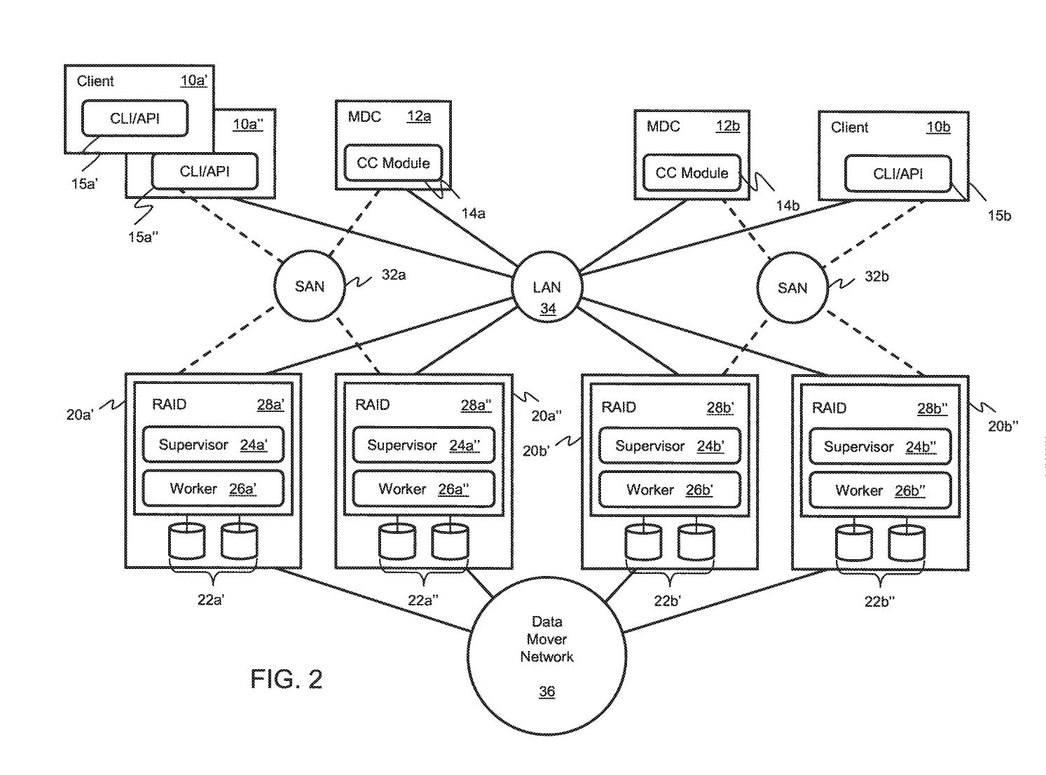

FIG. 2 is a block diagram of a networked storage system according to one embodiment of the invention. The system includes storage area networks (SANs) 32a, 32b (collectively 32) coupling one or more clients 10a′, 10a″, 10b (collectively 10) to one or more storage nodes 20a′, 20a″, 20b′, 20b″ (collectively 20). For example, in the illustrated embodiment, SAN 32a provides storage clients 10a′, 10a″ (collectively 10a) access to data stored in storage nodes 20a′, 20a″ (collectively 20a), and SAN 32b provides storage client 10b access to data stored in storage nodes 20b′, 20b″ (collectively 20b). Each SAN 32 may be implemented using a high-speed network technology such as, for example, Fibre Channel, Ethernet (e.g., Gigabit Ethernet or 10 Gigabit Ethernet), InfiniBand®, PCIe (Peripheral Component Interconnect Express), or any other network technology conventional in the art. The SANs 32 are coupled to one another over a data communications network 34. The data communications network may be an IP-based network, such as, for example, a local area network (LAN), wide area network (WAN), or any other IP or non-IP based data communications network conventional in the art.

Although the storage system of FIG. 2 depicts two storage nodes 20 coupled to a particular SAN 32, a person of skill in the art should recognize that the number of storage nodes may be greater or less than two. In addition, although the storage system depicts one or two clients coupled to a particular SAN, a person of skill in the art should recognize that the number of clients may also vary. Thus, embodiments of the present invention are not limited to any particular number of clients, storage nodes, nor SANs.

Each storage node 20 includes a mass storage device 22a′, 22a″, 22b′, 22b″ (collectively 22) such as, for example, an array of physical disk drives in a RAID (redundant array of independent disks). The various disks 22 in each storage node 20 are assembled using a disk array controller (e.g. RAID controller) 28a′, 28a″, 28b′, 28b″ (collectively 28) to form one or more logical/virtual drives. Each logical drive may be identified by a logical unit number (LUN) or any other identification mechanism conventional in the art. All or a portion of the physical hard disks 22 in the storage node 20 may be mapped to a logical drive identified by a LUN. The disk array controller 28 interfaces with the physical hard disks 22 via API function calls and direct memory interface. Any type of mass storage data may be stored in the physical hard disks, including, without limitation, video, still images, text, audio, animation, and/or other multimedia and non-multimedia data. Although the storage devices 22 are described as disks, a person of ordinary skill in the art should recognize that any block structured storage media may be used in addition or in lieu of disks.

Each storage client 10 is a desktop, laptop, tablet computer, or any other wired or wireless computer device conventional in the art. Each storage client includes a processor, memory, input unit (e.g. keyboard, keypad, mouse-type controller, touch screen display, and the like), and output unit (e.g. display screen). Each storage client 10 is coupled to a file system controller 12, also referred to as a metadata controller (MDC), via a private IP network (not shown) or the data communications network 34. The file system controller 12 stores and manages file system metadata for a clustered file system hosted by the clients 10. An exemplary file system may be a Quantum® StorNext® File System (SNFS), NTFS, ext3,Xfs, Lustre, GFS, GPFS, or any other cluster file system conventional in the art. The file system controller 12 may be implemented via software, firmware (e.g. ASIC), hardware, or any combination of software, firmware, and/or hardware. According to one embodiment, the file system controller 12 is installed in a dedicated server. An exemplary file system controller hosted by a dedicated server is StorNext® MDC. Alternatively, the file system controller 12 may be installed in a storage node 20 as part of, or separate from, the disk array controller 28. A person of skill in the art should recognize that other locations are also possible for hosting the file system controller 12, such as, for example, the storage client 10, and embodiments of the present invention are not limited to the expressly described locations.

According to one embodiment of the invention, the networked data storage system includes a private data mover network 36 for directly transferring data from one storage node 20 coupled to one SAN 32 to another storage node coupled to the same or different SAN. The private network 36 may be arranged in a switch fabric or other network topology conventional in the art. The fabric may be formed using Ethernet (e.g., Gigabit Ethernet or 10 Gigabit Ethernet), Fibre Channel, InfiniBand®, PCIe, or any other high bandwidth, low latency physical transport conventional in the art. The software architecture for the private data mover network 36 is independent of the particular physical transport that is used, and, as such, may be implemented over a variety of different physical transports. In addition, any of a variety of data transfer protocols (e.g., TCP/IP, UDP/IP, Small Computer System Interface (SCSI), Memory Mapping, and other remote DMA (RDMA) protocols) may be used to transfer data between the storage nodes 20.

The networked data storage system of FIG. 2 also includes one or more objects or modules for initiating and controlling the direct transfer of stored data. The modules include, without limitation, a user interface module 15a′, 15a″, 15b (collectively 15), a command and control (CC) module 14a, 14b (collectively 14), and a supervisor module 24a′, 24a″, 24b′, 24b″ (collectively 24). According to one embodiment, each of the modules is a software module implemented via computer program instructions stored in memory and executed by a processor. The computer program instructions may also be stored in non-transient computer readable media such as, for example, a CD-ROM, flash drive, or the like. In other embodiments, the modules may be implemented via hardware, firmware (e.g. via an ASIC), or in any combination of software, firmware, and/or hardware.

According to one exemplary embodiment, each user interface module 15 is hosted by a storage client 10 for providing an interface for users or other computing devices to initiate a data transfer. The interface might be, for example, a command line interface (CLI), application programming interface (API), web based graphical user interface (WebGUI), or any other user interface conventional in the art. The user interface may allow a user to select one or more files to be transferred, and a target location for the transfer. The target location may be the same storage node as the source of the files, or a different storage node within the same SAN or on a different SAN.

According to one exemplary embodiment, each command and control (CC) module 14 is hosted on the same device that hosts the file system controller 12, and is configured to receive a transfer command from the user interface module 15 and manage the data transfer process. In this regard, the CC module 14 determines which storage nodes 20, and LUNs owned by those storage nodes, need to be involved for the data transfer. Because data transfer requests are generally file based, the CC module generally needs knowledge of which logical data blocks belong to a particular file and on which storage node(s) 20 for translating a filename into a list of logical blocks and a list of storage nodes which own those blocks. A particular CC module 14 may also receive requests from a source CC module 14 to create a target file, allocate storage for it, and translate target file pathnames to lists of newly allocated extents/blocks that will receive the source data.

According to one exemplary embodiment, each supervisor module 24 runs on the disk array controller 28 of a particular storage node 20, and spawns worker threads 26a′, 26a″, 26b′, 26b″ (collectively 26) as needed to service the transfer requests. Depending on whether the storage node that it supervises is the source or the target of a particular data transfer, the supervisor takes the role of a source or target supervisor. When taking the role of a source, the supervisor module 24 takes data transfer requests from its parent CC module 14 and stores the request in a source queue. When taking the role of a target, the supervisor module 24 receives requests from a remote source supervisor module and stores the request in a target queue. As a person of skill in the art will appreciate, the supervisor module 24 may take the role of a source for one data transfer request, while concurrently taking the role of a target for a different data transfer request.

According to one embodiment, the supervisor module 24 invoked for a particular data transfer request spawns one or more worker threads 26 to handle the actual data transfer. If multiple data transfer requests are made to the supervisor module 24, the module spawns at least one separate worker thread for each data transfer request for concurrently transferring the files indicated in the multiple requests. Each source worker thread 26 is configured to retrieve data from a LUN to which it interfaces, and directly transfer the data to a target worker thread for storing in the target storage node.

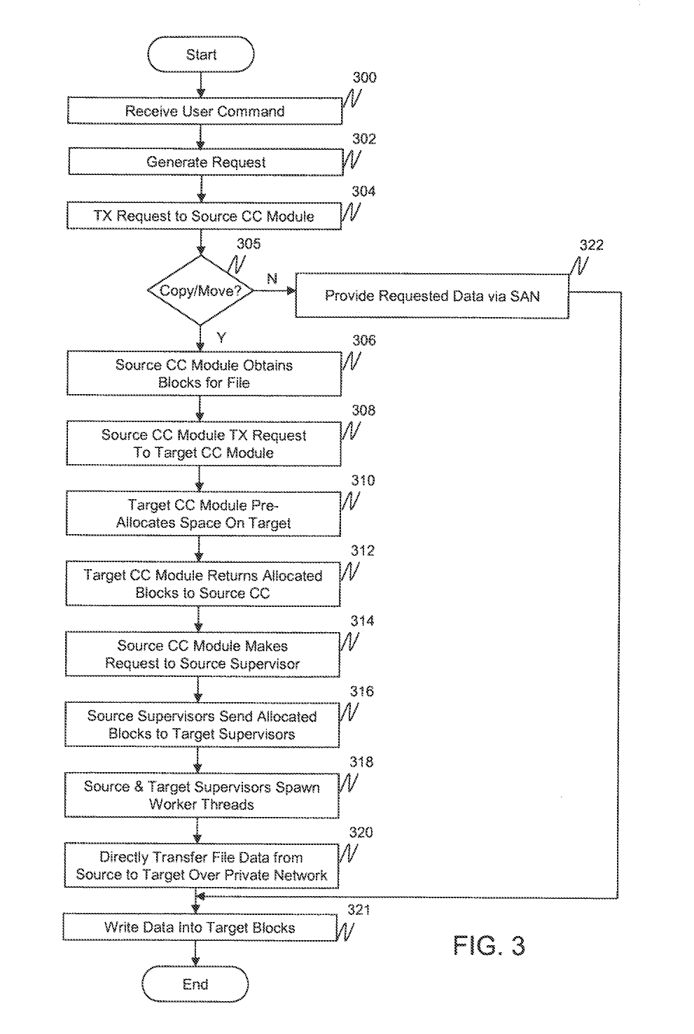

FIG. 3 is a flow diagram of a process executed by the various modules of the networked storage system of FIG. 2 for transferring a data file from a source location (e.g. SAN 32a) to a target location (e.g. SAN 32b) over the private network 36. The sequence of steps of the process is not fixed, but can be altered into any desired sequence as recognized by a person of skill in the art. Also, the person of skill in the art will recognize that one or more of the steps of the process may be executed concurrently with one or more other steps.

The process starts, and in step 300, a user command is received via the user interface module 15 of the initiating client 10a. The command may be a request to transfer data from a source location to a target location, or a simple retrieval/reading of the data without copying or moving the data to another location. According to one embodiment, a, request to transfer data includes sufficient information to identify the file to be transferred and the target location of the transfer. A request to transfer data may also be initiated by a computing device in communication with the source client 10a.

Where the data transfer is initiated by a user, the user identifies the file to be transferred by selecting the file from a list of files, entering a specific file path of the file to the transferred, or providing other identification for the file as is conventional in the art. Although a single file is described as being identified by the user, a person of skill in the art should recognize that the user may also select multiple files for being concurrently transferred in the same data transfer session. The user may further identify the target location to which the file is to be transferred. The target location may be identified by an address (e.g. an IP address) of the target SAN 32b. Alternatively, the user may identify the address, name, or another identifier of the target client 10b or target file system controller 12b. A person of skill in the art will recognize that embodiments of the present invention may utilize other conventional mechanisms to identify the source and target of the transfer without being limited to the particular mechanisms described herein. The user may further indicate whether the file is to be moved (deleting the file from the source), or replicated and then moved.

In step 302, the user interface module 15a bundles the user command into a request packet, and in step 304, transmits the request packet to the source CC module 14a over the data communications network 34. Alternatively, if the source client 10a is coupled to the source file system controller 12a over a private management network, the request packet may be transmitted to the source CC module 14a over the private management network. If the user command is a request to transfer data from a source to a target, the request packet may include, without limitation, the file path of the file to the transferred, and the address of the target location.

In step 305, the source CC module determines whether the received request is a request to copy or move the data from a source to a target. If the answer is YES, the source CC module 14a queries, in step 306, the file system managed by the file system controller 12a for obtaining one or more source LUNs and file extents/blocks within those LUNs for the file specified in the request packet. Any conventional mechanism for obtaining logical file block information for the specified file may be employed by the CC module 14a. For example, if the file system controller 12a is implemented as a StorNext File System, the source CC module 14a uses the StorNext API library (SNAPI) to interrogate the file system controller about the file to be transferred, and obtain the LUN and extent/block information associated with the file. In addition, if the file system/operating system includes a striping driver, the CC module or the file system API interrogates the striping driver to determine the mapping of file system extent information to the logical block numbers on the LUNs that are exported by the RAID systems 20. A goal of this operation is to obtain the logical block numbers on every LUN of each RAID system 20 that is involved in the file transfer operation. For example, if a particular file that is to be transferred is striped across two storage nodes 20a′, 20a″, the CC module identifies the source LUN and logical block numbers/file extents on each storage node 20a′, 20″ that store chunks of the file. If the source CC module 14 does not have direct access to the file system to process the request, it communicates with other modules that do have access to such file system data. Although embodiments of the present invention identify storage areas of the storage nodes via LUNs and file extents, a person of skill in the art should recognize that other forms of identifying the storage areas may also be used.

The direct access by the CC module 14a to the file system metadata allows the CC module to create a Scatter/Gather map of the source LUNs and associated logical data blocks that contain the data to be transferred to the target location. The source CC module 14a may further identify the storage node(s) 20a′, 20a″ associated with the identified source LUNs.

In step 308, the source CC module 14a generates a second request packet including, without limitation, the filename and size of the file to be transferred, and transmits the second packet to the target CC module 14b over the data communications network 34. According to one embodiment, the source CC module 14a identifies the address of the target file system controller 12b based on the address of the target SAN 32b provided by the user. The identification of the target file system controller 12b automatically identifies the target CC module 14b that is to receive the second request packet.

In step 310, the target CC module 14b receives the second request packet from the source CC module and pre-allocates space in the target file system for the file to be transferred according to any pre-allocation mechanism conventional in the art. For example, the target CC module 14b may make a request to the target storage nodes 20b′, 20b″ for allocation of storage space that corresponds to the size of the data that is to be received, and the target storage nodes may respond with available block numbers that it will reserve for the later data transfer. For purposes of this example, it is assumed that the file is to be striped across two target storage nodes 20b′, 20b″. In this regard, the target CC module identifies one or more target LUNs, file extents/blocks within the target LUNs, and one or more storage nodes 20b′, 20b″ associated with the identified target LUNs, that are to store the transferred file. In addition, if the file system/operating system includes a striping driver, the CC module or the file system API interrogates the striping driver to determine the mapping of file system extent information to the logical block numbers on the LUNs that are exported by the RAID systems 20. A goal of this operation is to obtain the logical block numbers on every LUN of each RAID system that is involved in the file transfer operation. The identified target LUNs and file extents and associated physical blocks are reserved for the file to be received from the source and not used to store other data received by the target storage nodes 20b.

In step 312, the target CC module 14b returns the allocated target logical blocks to the source CC module 14a over the data communications network 34. According to another embodiment, the target CC module 14b may return the target LUNs and file extents. The target CC module 14b may further return the addresses of the target storage nodes 20b′, 20b″ associated with allocated target logical blocks.

In step 314, the source CC module 14a makes a request to the source supervisor 24a′, 24a″ in each storage node 20a′, 20a″ over the data communications network 34. The information passed to the source supervisors 24a′, 24a″ with the request may include, for example, a list of source logical blocks, a list of target logical blocks, and identification of the target storage nodes 20b′, 20b″ corresponding to the target logical blocks. Each source supervisor 24a′, 24a″ stores the request and associated information from the parent CC module 14a in a source queue (not shown) for handling.

In step 316, each source supervisor 24a′, 24a″ communicates, over the private network 36, with one of the target supervisors 24b′, 24b″ in the target storage node 20b′, 20b″ where the transferred file is to be stored. According to one embodiment, each source supervisor 24a′, 24a″ passes to one of the target supervisors 24b′, 24b″ the target logical blocks that have been pre-allocated for the file to be transferred. According to one embodiment, each target supervisor 24b′, 24b″ stores the incoming request and associated information from a peer source supervisor 24a′, 24a″, in a target queue (not shown) for handling.

In step 318, the source and target supervisors 24 each spawn one or more worker threads 26 for processing the data transfer. According to one embodiment, the supervisor threads communicate with the spawned worker threads over a private path including, for example, sockets, pipes, shared memory, and the like. For example, each source supervisor 24a′, 24a″ spawns at least one source worker thread 26a′, 26a″ for interacting with the disk array controller 28a′, 28a″ of the corresponding storage node 20a′, 20a″. Each source worker thread retrieves the chunks of the file that are physically present on its storage node. The access is based on the source logical blocks provided to the worker threads 26a′, 26a″. The actual data retrieval from the physical blocks is based on RAID controller API function calls and direct memory interface, although embodiments of the present invention contemplate other conventional mechanisms of accessing the data stored in the identified source blocks. In performing the data retrieval, each source worker thread 26a′, 26a″ interacts with the disk array controller 28a′, 28a″ to read the data from the source blocks into a memory of the controller. The determination of which physical blocks of the mass storage devices 22a′, 22a″ correspond to the source logical blocks is done by the corresponding controllers 28a′, 28a″ according to conventional mechanisms.

Each target supervisor 24b′, 24b″ also spawns at least one target worker thread 26b′, 26b″ for interfacing with the disk array controller 28b′, 28b″ to store the received data based on the target logical blocks. Each target supervisor may send to the source supervisors 24a′, 24a″, the work thread identifier spawned for handling the transfer. Any type of identifier that identifies the target storage nodes 20b′, 20b″ and/or target worker threads 26b′, 26b″ that are to ultimately receive chunks of data that are to be transferred are contemplated, including without limitation, full or partial IP addresses, names, ID numbers, and the like.

In step 320, each spawned source worker thread 26a′, 26a″ directly transfers the data that was written into the memory of the source controller 28a′, 28a″, to a particular target worker thread 26b′, 26b″, in a point-to-point dynamic interconnect using the private data network 36. Each spawned source worker thread 26a′, 26a″ is configured to transfer the data to the corresponding target worker thread 26b′, 26b″ based on the identifier to such target worker thread. In this regard, each spawned source worker thread 26a′, 26a″ reads the data written into the memory of the corresponding controller 28a′, 28a′ and generates a request packet including the read data. The request packet may further include, without limitation, the identifier of the target worker thread and/or target storage node 20b′, 20b″ to receive the request packet, and a list of the target LUNs and associated file extents in which to store the transferred data. The source worker threads 26a′, 26a″ may further be configured to establish the direct point-to-point connection with the target storage nodes 20b′, 20b″ over a point-to-point communication channel provided by the private data network.

In step 321, each target worker thread 26b′, 26b″ receives the request packet from the corresponding source worker thread 26a′, 26a″ and interacts with its disk array controller 28b′, 28b″ to write the received data into the physical blocks of the target mass storage devices 22b′, 22b″ that correspond to the target LUNs and associated file extents.

In this manner, neither the SAN nor the data communications network 34 is used for the transfer of the actual data stored in the storage node(s). Furthermore, aside from the initial command that initiates the data transfer, no storage clients are involved in the actual movement of the data from the source storage node to the target storage node. As such, the data is transferred independent of client involvement at both the source and target locations, as well as without involving the SANs coupled to the storage clients. Depending on the fabric that is used for the private data network, the storage nodes 20 may drive data up to line speeds without interfacing with the SANs 32 or data communications network 34. Accordingly, normal operations which continue to use the SAN to simply retrieve data from the one or more storage node(s) without copying or moving the data to another location, are not impacted by the data transfer operations. For example, with the embodiments of the present invention, a client may use the SAN to retrieve data to make edits to the data without encountering traffic that carries other data that is intended to be copied or moved to another location.

The worker threads 26 exit after the data transfer completes (normally or abnormally), and status in formation is returned to the parent supervisor modules 24. The supervisor modules 24 collect the status information and report the information back to the corresponding parent CC modules 14. Errors encountered during the transfer may be handled according to any conventional error handling policy. For example, the supervisor modules 24 may attempt to retry the job or simply return a failed status to the parent CC module 14 for allowing the CC module determine if and how to restart the data transfer job based on its internal policy.

Referring again to step 305, if the request provided by the user is not a request to copy or move the data from a source to a target, the request is handled as it would conventionally in step 322. That is, the requested data is provided to the initiating client 10a via the SAN 32a.

In the process described with respect to FIG. 3, the list of the target logical blocks are passed to the target supervisors 24b′, 24b″ by the source supervisors 24a′, 24a″. A person of skill in the art should recognize, however, that the block list may alternatively be passed to the target supervisors 24b′, 24b″ by the parent target CC module 14b or any other module residing at the source or target location. Thus, embodiments of the present invention are not limited to the particular manner in which source and target logical block lists are passed to the corresponding supervisors and/or worker threads. All conventional mechanisms for conveying this information are contemplated.

A person of skill in the art should recognize that the process of transferring data between two different SANs as described with respect to FIG. 3 is also applicable to a process of transferring data between storage nodes within the same SAN, such as, for example, transfers between storage nodes 20a′ and 20a″. In addition, embodiments of the present invention provide improved network performance even where the source and target locations for a transfer are within the same file system within the same storage node 20 (intra-storage transfer).

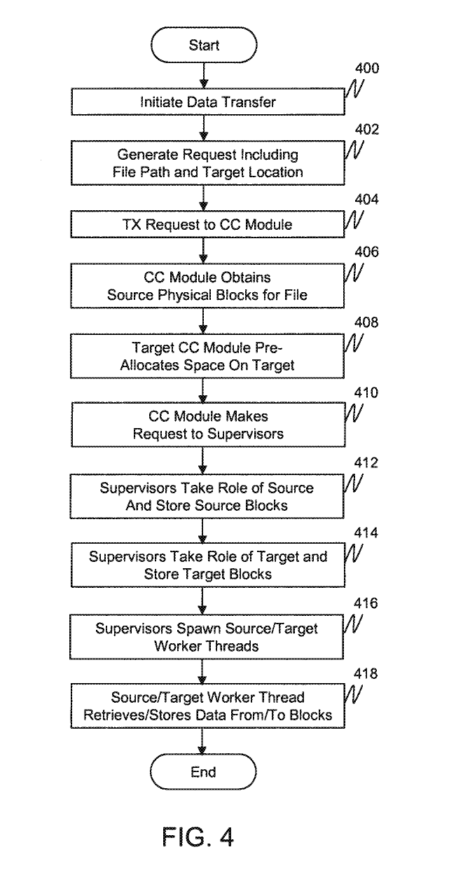

FIG. 4 is a flow diagram of a process for intra-storage transfer according to one embodiment of the invention. The sequence of steps of the process is not fixed, but can be altered into any desired sequence as recognized by a person of skill in the art. Also, the person of skill in the art will recognize that one or more of the steps of the process may be executed concurrently with one or more other steps. For purposes of this example, it is assumed that the file to be transferred is striped across source storage nodes 20a′, 20a″, and that after its transfer, the file is striped across target storage nodes 20a′, 20a″

The process starts, and in step 400, the user interface module 15a at the source client 10a is invoked for initiating the intra-storage transfer. According to one embodiment, the client indicates an intra-storage transfer by copying a file from a source folder and identifying a target folder in which to store the copied file as the target location. The target folder may be the same or different than the source folder.

In step 402, the user interface module 15a bundles the file path information and target location provided by the user into a request packet, and in step 404, transmits the request packet to the CC module 14a in a manner similar to step 304 of FIG. 3. The request packet may include, without limitation, the file path of the file to the transferred, and the address of the target location.

In step 406, the CC module 14a queries the file system managed by the file system controller 12a for obtaining one or more source logical blocks for the file specified in the request packet, in a manner similar to step 306 of FIG. 3.

In step 408, the CC module 14a identifies the target location as being within the same SAN as the source location by comparing, for example, the address of the source SAN with the address of the target SAN, and pre-allocates space in the file system in a manner similar to step 310 of FIG. 3. In pre-allocating the space, the CC module 14a identifies one or more target logical blocks, and storage nodes 20a′, 20a″ associated with the identified target logical blocks, that are to store the transferred file.

In step 410, the CC module 14a makes a request to the supervisor 24a′, 24a″ in each storage node 20a′, 20a″ storing the desired file, over the data communications network 34. The information passed to the supervisors with the request may include, for example, a list of source logical blocks from which to retrieve the file, and a list of target logical blocks in which to store a new copy of the file.

In step 412, each supervisor 24a′, 24a″ takes the role of a source and stores at least the source logical blocks in source queue (not shown) for handling.

In step 414, each supervisor 24a′, 24a″ also takes the role of a target and stores at least the target logical blocks in a target queue (not shown) for handling.

Depending on the role, each supervisor 24a′, 24a″ spawns a source or target worker thread in step 416, for respectively retrieving data from, or storing data into, the corresponding blocks of the mass storage devices 22a′, 22a″. Specifically, each source worker thread 26a′, 26a″ interacts with the disk array controller 28a′, 28a″ to copy the data in the source logical blocks into a memory of the controller. Each target worker thread (not shown) also interacts with the disk array controller 28a′, 28a″ to take the data copied into the memory, and write it into the physical blocks of the mass storage devices 22a′, 22a″ that correspond to the target logical blocks.

As a person of skill in the art should recognize, the intra-storage data transfer mechanism of FIG. 4 bypasses the SAN 32a and thus, avoids creating traffic on the SAN 32a that would generally occur during a conventional intra-storage data transfer event. Instead of traversing through the SAN (e.g. once for reading the data and once for writing the data), data is simply read into the memory of the disk array controller 28a′, 28a″, and the read data is written to physical blocks of the mass storage devices 22a′, 22a″ that correspond to the target logical blocks without traversing the SAN.

According to one embodiment of the invention each CC module 14 maintains enough information about the supervisors 24, storage nodes 20, and LUNs within the storage nodes, to understand which resources are controlled by each supervisor. Each supervisor module registers with the parent CC module 14 in order to provide this understanding to the CC module.

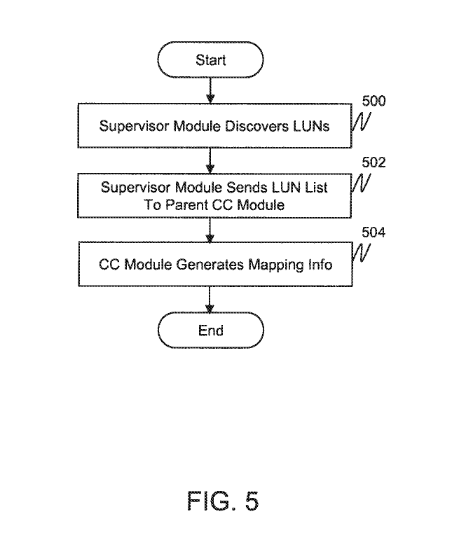

FIG. 5 is a flow diagram of a process for registering a supervisor module 24 with a parent CC module 14 according to one embodiment of the invention. The sequence of steps of the process is not fixed, but can be altered into any desired sequence as recognized by a person of skill in the art. Also, the person of skill in the art will recognize that one or more of the steps of the process may be executed concurrently with one or more other steps.

The registration process may be invoked, for instance, during power-up of the storage node 20 hosting the supervisor module 24. In this regard, in step 500, the supervisor module 24 discovers available LUNs in the corresponding storage node 20. The discovery is performed according to any conventional mechanism known in the art. According to one embodiment, the supervisor module 24 resides on the disk array controller 28 and has access via an internal controller API to the list of all LUNs and the information that describes those LUNs such as, for example, LUN Inquiry Data (e.g. identifiers, make, model, serial number, manufacturer, and the like). The supervisor module issues commands via the controller API to obtain information about all LUNs that the controller is presenting. The LUN information is collected into an internal data structure and subsequently sent to the CC module.

In step 502, the supervisor module sends the list of LUNs to the parent CC module 14. According to one embodiment, the supervisor module transmits the list of LUNs in a broadcast message along with a request for registration. Each LUN is identified by a serial number which is unique for each LUN within a SAN. The request for registration may also contain a supervisor ID for the registering supervisor module 24, and storage node ID of the storage node 20 hosting the supervisor. Although a broadcast protocol is anticipated, other conventional mechanisms of transmitting the request may also be employed.

In step 504, the parent CC module 14 receives the request for registration and maps the list of LUNs to the corresponding supervisor ID and/or the storage node ID. The mapping information may be stored, for example, in a mapping table stored in a memory accessible to the CC module 14. According to one embodiment of the invention, the mapping table may further contain the LUNs' pathnames, band major/minor numbers on the file system controller 12, and/or other information on how data is stored in the file system.

According to one embodiment, addition or removal of LUNs cause the corresponding supervisors to send updates to the parent CC modules 14. In this manner, the CC modules are kept up to date of the available resources controlled by the supervisor modules 24.

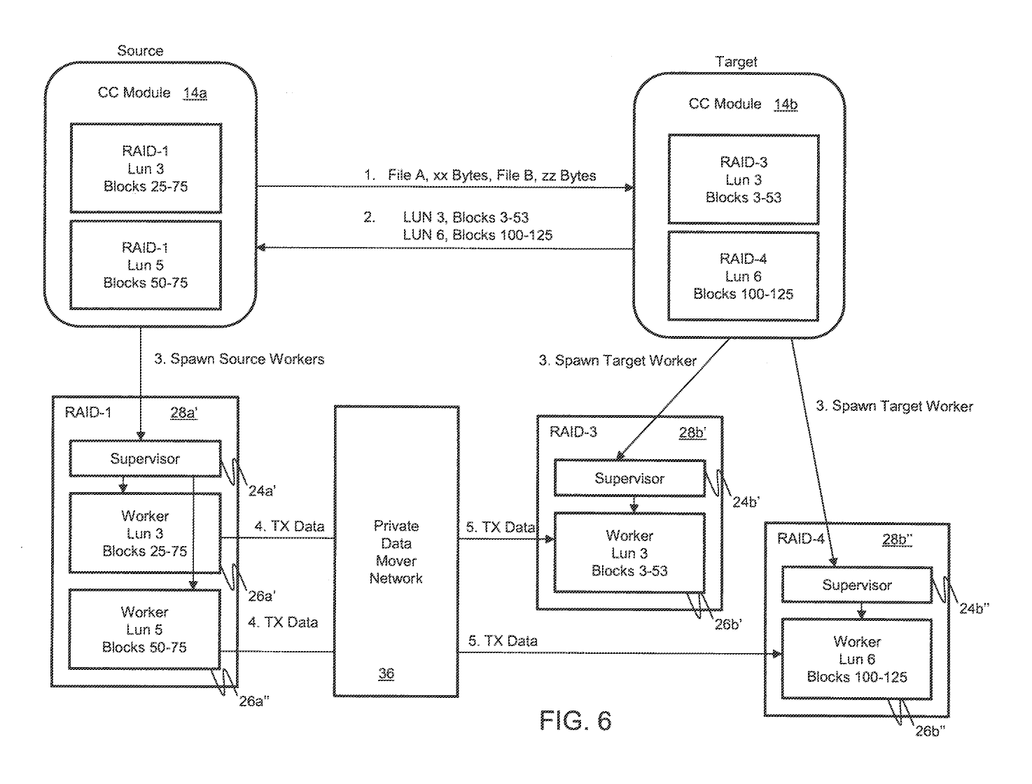

FIG. 6 is a block diagram illustrating an exemplary data transfer of files stored in specific LUNs according to one embodiment of the invention. According to the illustrated example, the CC module at a source location (e.g. CC module 14a) receives a request to transfer two files to a target location. The source CC module 14a communicates with the file system controller 12a and determines that one file is located in blocks 25-75 of LUN 3, and a second file located in blocks 50-75 of LUN 5, both of which are controlled by a first controller 28a′ (e.g. a RAID-1 controller).

The source CC module 14a sends a request with the names of the files and the corresponding file sizes to the CC module at the target location (e.g. CC module 14b). The target CC module 14b allocates space for the first file in blocks 3-53 of LUN 3 under a second controller 28b′ (e.g. RAID-3 controller), and space for the second file in blocks 100-125 of LUN 6 under a third controller 28b″ (e.g. RAID-4 controller). According to one embodiment, the allocation information is sent back to the source CC module 14a.

The target CC module 14b requests the target supervisor modules 24b′ and 24b″ to set up the target worker threads 26a′, 26b″ to receive the data transfer. Alternatively, the request may be transmitted by the source supervisor module 24a′ in a peer-to-peer communication.

The source CC module 14a also requests the source supervisor module 24a° to set up the source worker threads 26a′, 26a″ for concurrently transferring the data in blocks 25-75 of LUN 3, and blocks 50-75 of LUN 5, over the private data mover network 36, to target worker threads 26b′ and 26b″, respectively. In this regard, each source worker thread 26a′, 26a″ receives the ID of the target worker thread 26b′, 26b″ to which it is to transmit its retrieved data.

Once the data is received, the target worker threads 26b′, 26b″ concurrently write the received data to blocks 3-53 of LUN 3, and blocks 100-125 of LUN 6, respectively. The source and target worker threads report their status to their corresponding supervisor modules, and terminate when the data transfer is complete, or when they encounter an unrecoverable error.

As a person of skill in the art will appreciate, embodiments of the present invention have minimum impact on the I/O performance of the data communications network 34 and/or SAN 32 since the storage nodes 20 have direct local physical access to disk drives 22. Thus, the data communications network 34 and/or SAN 32 may be fully utilized for normal production data traffic. Furthermore, the private network 36 allows the multiple storage nodes 20 to transfer data in parallel in a point-to-point dynamic interconnect, making the data transfer faster than in conventional systems that utilize the SAN 32 and/or data communications network 34 for the data transfer. Using an intelligent, fast, and fabric appropriate switch, the storage nodes 20 can drive data at up to line speeds without inter-node interference.

### Alternative Embodiments

According to another embodiment of the invention, a single master worker thread (MWT) is spawned at each storage node 20. Instead of spawning a separate worker thread for each data transfer request, the source MWT receives instructions from the CC module 14 for the multiple data transfers and does all the work of retrieving all of file's extents/blocks and shipping them to the target MWT on another SAN. This embodiment may be simpler than the above described embodiment and may reduce setup costs due to the fact that only one worker thread is spawned. However, it may result in reduced performance because it uses a single network connection from a single storage node to send all of the data to other storage nodes and does not perform simultaneous transfers as is the case with multiple worker threads.

Another embodiment is structurally similar to the embodiments described above, with the difference being that a copy of the file system client (e.g., the SNFS client) runs on each storage node 20 in a SAN. According to this embodiment, the source worker threads use standard file system calls to retrieve the data to be transferred to a target SAN. Because each storage node runs its own copy of the file system client, the source worker thread on the particular node retrieves only chunks of the file that are physically present on that node. Although such an embodiment may reduce system complexity by allowing the worker threads direct access to file system information, it may result in increased costs due to licensing fees that may be required to install the file system client on each storage node. In addition, the overhead of the file system client in the I/O path may also reduce performance.

Another embodiment of the present invention is similar to the embodiment with a single master worker thread, except that it differs by including a single copy of the file system client per SAN that runs on one of the storage nodes. This local file system client knows how to access all of the source file data regardless of how it is distributed over multiple storage nodes 20.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A networked data storage system comprising:
a source mass storage device storing source data, wherein the source mass storage device is coupled to a source client via a storage area network (SAN);
a target mass storage device coupled to the source mass storage device via a private data network;
wherein, in response to a first type of request from the source client, the source mass storage device is configured to provide the source data to the source client via the SAN, and in response to a second type of request from the source client, the source mass storage device is configured to provide the source data to the target mass storage device via the private data network, wherein in providing the source data to the target mass storage device, the source mass storage device is configured to receive an identifier identifying the target mass storage device.

2. The networked data storage system of claim 1, wherein the first type of request is a request to read the source data and the second type of request is a request to copy or move the source data to the target mass storage device.

3. The networked data storage system of claim 1, wherein the source mass storage device is configured to determine the identifier identifying the target mass storage device based on information provided in the second type of request.

4. The networked data storage system of claim 3, wherein the information provided in the second type of request is an address of a target SAN, wherein the target mass storage device is coupled to a target client via the target SAN.

5. The networked data storage system of claim 4, wherein the target SAN is the same as the SAN coupling the source client to the source mass storage device.

6. The networked data storage system of claim 1, wherein the source storage device includes a processor and a memory storing computer program instructions, the processor being configured to execute the program instructions, the program instructions including:
receiving a list of source blocks;
retrieving the source data based on the source blocks;
writing the retrieved source data in the memory;
reading the source data from the memory;
generating a request packet including the read source data;
establishing connection with the target mass storage device; and
transmitting the request packet to the target mass storage device via the established connection.

7. The networked data storage system of claim 6, wherein the connection is a point-to-point connection.

8. The networked data storage system of claim 6, wherein the source blocks are identified by a file system controller based on file system metadata.

9. The networked data storage system of claim 1, wherein the target mass storage device is configured to pre-allocate storage space for storing the source data.

10. The networked data storage system of claim 9, wherein the target mass storage device is configured to receive the source data from the source mass storage device and store the received source data in the pre-allocated storage space.

11. The networked data storage system of claim 1, wherein the source data is stored in a plurality of source mass storage devices, wherein each of the plurality of source mass storage devices is configured to concurrently retrieve a portion of the source data and provide the retrieved portion to one or more target mass storage devices for storing therein.

12. The networked data storage system of claim 1, wherein in response to a plurality of second type requests from one or more source clients, the source mass storage device is configured to concurrently provide data requested by each of the plurality of second type requests, to one or more target mass storage devices, for concurrently storing the data in the one or more target mass storage devices.

13. The networked data storage system of claim 1, wherein the private data network provides a point-to-point communication channel between the source mass storage device and the target mass storage device for transferring the source data from the source mass storage device to the target mass storage device.

14. The networked data storage system of claim 1, wherein the source data from the source mass storage device is transferred to the target mass storage device independent of involvement by the source client in moving the source data.

15. The networked data storage system of claim 1, wherein in response to a third type of request from the source client, the source mass storage device is configured to transfer the source data from a first location in the source mass storage device to a second location in the source mass storage device, wherein the transfer bypasses the SAN.

16. In a networked data storage system including a source mass storage device coupled to a source client via a storage area network (SAN), and a target mass storage device coupled to the source mass storage device via a private data network, a method for transferring source data stored in the source mass storage device comprising:
in response to a first type of request, providing the source data to the source client by the source mass storage device via the SAN; and
in response to a second type of request, providing to the source mass storage device an identifier identifying the target mass storage device, and further providing, based on the identifier, the source data to the target mass storage device via the private data network.

17. The method of claim 16, wherein the first type of request is a request to read the source data and the second type of request is a request to copy or move the source data to the target mass storage device.

18. The method of claim 16, wherein the determining of the identifier identifying the target mass storage device is based on information provided in the second type of request.

19. The method of claim 18, wherein the information provided in the second type of request is an address of a target SAN, wherein the target mass storage device is coupled to a target client via the target SAN.

20. The method of claim 19, wherein the target SAN is the same as the SAN coupling the source client to the source mass storage device.

21. The method of claim 16 further comprising:
receiving by the source mass storage device a list of source blocks;
retrieving by the source mass storage device the source data based on the source blocks;
writing by the source mass storage device the retrieved source data in the memory;
reading by the source mass storage device the source data from the memory;
generating by the source mass storage device a request packet including the read source data;
establishing by the source mass storage device connection with the target mass storage device; and
transmitting by the source mass storage device the request packet to the target mass storage device via the established connection.

22. The method of claim 21, wherein the connection is a point-to-point connection.

23. The method of claim 21, wherein the source blocks are identified by a file system controller based on file system metadata.

24. The method of claim 16 further comprising:
pre-allocating by the target mass storage device storage space for storing the source data.

25. The method of claim 24 further comprising:
receiving by the target mass storage device the source data from the source mass storage device; and
storing the received source data in the pre-allocated storage space.

26. The method of claim 16, wherein the source data is stored in a plurality of source mass storage devices, the method comprising:
concurrently retrieving by each of the plurality of source mass storage devices a portion of the source data; and
providing the retrieved portion to one or more target mass storage devices for storing therein.

27. The method of claim 16 further comprising:
in response to a plurality of second type requests from one or more source clients, concurrently providing by the source mass storage device data requested by each of the plurality of second type requests, to one or more target mass storage devices, for concurrently storing the data in the one or more target mass storage devices.

28. The method of claim 16, wherein the private data network provides a point-to-point communication channel between the source mass storage device and the target mass storage device for transferring the source data from the source mass storage device to the target mass storage device.

29. The method of claim 16, wherein the source data from the source mass storage device is transferred to the target mass storage device independent of involvement by the source client in moving the source data.

30. The method of claim 16 further comprising:
in response to a third type of request from the source client, transferring by the source mass storage device the source data from a first location in the source mass storage device to a second location in the source mass storage device, wherein the transfer bypasses the SAN.
